(19) United States
(12) Patent Application Publication
(10) Pub. No.: US 2010/0221971 A1
(43) Pub. Date: Sep. 2, 2010

(54) WATER-REPELLENT/OIL-REPELLENT AGENT TO BE ADDED TO THERMOPLASTIC RESIN

(75) Inventors: Kouji Kubota, Settsu-shi (JP); Norimasa Uesugi, Settsu-shi (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka-shi, Osaka (JP)

(21) Appl. No.: 12/161,750

(22) PCT Filed: Jan. 22, 2007
(86) PCT No.: PCT/JP2007/050910

§ 371 Date: Jul. 22, 2008

Related U.S. Application Data
(60) Provisional application No. 60/761,361, filed on Jan. 24, 2006.

(51) Int. Cl. C08F 220/52; D04H 13/00; C08G 73/10; C08F 220/22; C08F 222/40; C08L 35/00

(52) U.S. Cl. 442/327; 528/322; 526/243; 526/245; 526/248; 525/55

(57) ABSTRACT

Disclosed is a water-repellent/oil-repellent agent which is composed of a fluorine-containing polymer containing a repeating unit (A) derived from a fluorine-containing monomer having a fluoroalkyl group or a fluoroalkenyl group, and a repeating unit (B) derived from a monomer having an imide group at a weight ratio of from 10/90 to 95/5 (repeating unit (A)/repeating unit (B)). Also disclosed is a thermoplastic resin composition which is obtained by adding such a water-repellent/oil-repellent agent into a thermoplastic resin. Since the fluorine-containing polymer is improved in heat resistance, the water-repellent/oil-repellent agent is capable of imparting a wide range of thermoplastic resins with excellent water repellency and oil repellency.

### TECHNICAL FIELD

The present invention relates to a fluorine-containing polymer; a water- and oil-repellent agent to be added to a thermoplastic resin; a thermoplastic resin composition comprising the water- and oil-repellent agent and the thermoplastic resin; and a molded article formed from the thermoplastic resin composition.

### BACKGROUND ART

Hitherto, known are technologies of subjecting a surface of a resin molded article to a fluorine treatment in order to impart the water- and oil-repellency to the surface. A method of conducting the fluorine treatment after the molding, however, has the problem that the durability of water- and oil-repellency is poor so that the repeated use makes the water- and oil-repellency to be deteriorated. In order to solve this problem, the studies have been made that a fluorine-containing compound is added to a resin and then melt-kneaded before the molding of resin so that a fluorine component is segregated on a surface after the molding, to impart the water- and oil-repellency.

The present inventors also, in JP-A-10-168324, proposed a fluorine-containing acrylate polymer to be added to a resin, as the water- and oil-repellent agent which can segregate a fluorine component on a surface to give water- and oil-repellency. However, because actually the heat resistance of the fluorine-containing acrylate polymer is insufficient, the fluorine-containing acrylate polymer has the problems that the fluorine-containing acrylate polymer, added to a nylon-66 resin and polyester resin having a molding temperature of 250-290° C., thermally decomposes and cannot impart enough water- and oil-repellency, and that a use application is limited to polyethylene resin or polypropylene resin having a relatively low molding temperature of 180-230° C. A fluorine-containing polymer having high heat-resistance is required in view of such a background.

Described below are the environmental problems raised by perfluorooctanoic acid (PFOA). The results of the latest researches [a report of the Environmental Protection Agency (EPA), “PRELIMINARY RISK ASSESSMENT OF THE DEVELOPMENTAL TOXICITY ASSOCIATED WITH EXPOSURE TO PERFLUOROOCTANOIC ACID AND ITS SALTS” (http://www.epa.gov/opptintr/pfoa/pfoara.pdf)] have taught that PFOA (perfluorooctanoic acid), one of long chain fluoroalkyl compounds, is proved to have a danger to burden the environment. Under such a situation, EPA (Environmental Protection Agency of USA) announced on Apr. 14, 2003 that the scientific investigation on PFOA should be more intensively executed.

On the other hand, Federal Register (FR Vol. 68, No. 73/Apr. 16, 2003 [FRL-2303-8]) (http://www.epa.gov/opptintr/pfoa/pfoafr.pdf), EPA Environmental News for release Monday April, 2003 “EPA INTENSIFIES SCIENTIFIC INVESTIGATION OF A CHEMICAL PROCESSING AID” (http://www.epa.gov/opptintr/pfoa/pfoaprs.pdf), and EPA OPPT FACT SHEET Apr. 14, 2003 (http://www.epa.gov/opptintr/pfoa/pfoafacts.pdf) announced that a “telomer” may possibly metabolize or decompose to PFOA. The telomer means a long chain fluoroalkyl group. It is also announced that the “telomer” is used in a large number of commercial products including fire fighting foams, care products and cleaning products as well as soil, stain and grease resistant coating on carpets, textiles, paper, and leather.

### [Patent Document 1]: JP-A-10-168324

### DISCLOSURE OF INVENTION

### Problems to be Solved by the Invention

An object of the present invention is to provide a water- and oil-repellent agent which can give superior water- and oil-repellency for also a thermoplastic resin having a high molding temperature by improving heat resistance of the fluorine-containing polymer.

### Means for Solving the Problems

The present inventors discovered that the fluorine-containing polymer prepared by polymerizing a monomer composition essentially comprising a monomer having a fluoroalkyl group and a monomer having an imide group can have the improved thermal resistance and can impart the sufficient water- and oil-repellency to the resin in comparison to the conventional fluorine-containing acrylate polymer free from the monomer having an imide group. Then the present invention was completed.

The present invention provides a fluorine-containing polymer comprising:

(A) repeating units derived from a fluorine-containing monomer having a fluoroalkyl group or fluoroalkenyl group, and
(B) repeating units derived from a monomer having an imide group,
wherein a weight ratio of the repeating units (A) to the repeating units (B) is from 10/90 to 95/5.

The present invention provides a water- and oil-repellent agent comprising the above-mentioned fluorine-containing polymer.

Also, the present invention provides a thermoplastic resin composition prepared by adding the above-mentioned water- and oil-repellent agent to a thermoplastic resin; and a molded article shaped from this thermoplastic resin composition. The shape of the molded article includes a fiber, a film and a tube.

### EFFECTS OF THE INVENTION

According to the present invention, superior water- and oil-repellency can be given for a wide range of thermoplastic resins such as a nylon resin and polyester resin having a relatively high molding temperature in addition to a polyethylene resin or polypropylene resin having a relatively low molding temperature by improving heat resistance of the fluorine-containing polymer. The thus obtained molded article can be used for the products such as a household article (for example, a washbowl), stationery (for example, an ink bottle), a carpet, a building material, an interior decoration material, a sanitary article and a medical article. Also, it can be used as a nonwoven fabric formed by fibers comprising the thermoplastic resin compositions.

### MODE FOR CARRYING OUT THE INVENTION

The fluorine-containing polymer of the present invention comprises:

(A) repeating units derived from a fluorine-containing monomer having a fluoroalkyl group or fluoroalkenyl group, and
(B) repeating units derived from a monomer having an imide group,
wherein a weight ratio of the repeating units (A) to the repeating units (B) is from 10/90 to 95/5.

The fluorine-containing monomer (a) deriving repeating units (A) is preferably represented by the general formula (1):

C(-A)(-D)=C(—X)—Y-[Q-Z-]ₚ-T-Rf (1)

wherein
A, D and X each is a hydrogen atom, a methyl group, a linear or branched alkyl group having 2 to 20 carbon atoms, a fluorine atom, a chlorine atom, a bromine atom, a iodine atom, a CFL¹L² group (wherein L¹ and L² is a hydrogen atom, a fluorine atom or a chlorine atom), a cyano group, a linear or branched fluoroalkyl group having 1 to 20 carbon atoms, a substituted or unsubstituted benzyl group, or a substituted or unsubstituted phenyl group;
Y is —C(═O)—O—, —C(═O)—NH—, —O— or —O—(CF₂CF(—CF₃)O—)_{g}— (wherein g is 1 to 21);
Q is —(CH₂)ₙ— or —(CH₂)ₙ—N(-Q¹)- in which n is 1 to 10, Q¹ is a hydrogen atom or C_{q}H_{2q+1} wherein q is 1 to 30;
Z is —S—, —SO—, —SO₂— or —C(—Z¹)(—Z²)— in which Z¹ and Z² each is a hydrogen atom, —OH or —OCO—C_{w}H_{2w+1} wherein w is 1 to 30;
T is a direct bond, an aliphatic group having 1 to 10 carbon atoms, or an aromatic or cycloaliphatic group having 6 to 20 carbon atoms;
Rf is a linear or branched fluoroalkyl group or fluoroalkenyl group having 1 to 21, in particular 1 to 6 carbon atoms; and
p is 0 or 1.

The fluorine-containing monomer (a) may be, for example, an acrylate ester compound, an acrylamide compound or a vinyl ether compound.

The specific examples of T are as follows.

—(CH₂)ₘ—

wherein m is 0 to 10, for example, 1 to 5,

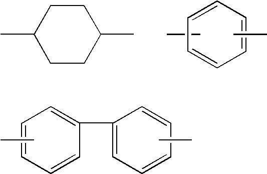

In a general formula (1), the Rf group is preferably a perfluoroalkyl group or a perfluoroalkenyl group. The carbon number of the Rf group may be 1-21, particularly 1-6, especially 1-5, for example, 1-4. When the Rf group is the fluoroalkyl group, examples of the Rf group include —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅CF₃, —(CF₂)₃CF(CF₃)₂, —(CF₂)₄CF(CF₃)₂, —(CF₂)₇CF₃, —(CF₂)₅CF(CF₃)₂, —(CF₂)₆CF(CF₃)₂ and —(CF₂)₉CF₃. When the Rf group is the fluoroalkenyl group, examples of the Rf group include —C(CF(CF₃)₂)═C(CF₃)(CF₂CF₂CF₃), —C(CF(CF₃)₂)═C(CF₃)(CF(CF₃)₂) and —C(CF₃)═C(CF(CF₃)₂)₂.

The following compounds can be illustrated as Specific examples of the general formulae (1), but are not limited to these.

Specific examples of the acrylate ester compound or the acrylamide compound:

### CH₂═C(—H)—C(═O)—O—(CH₂)₁₀—Rf

### CH₂═C(—CH₃)—C(═O)—O—(CH₂)₁₀—Rf

### CH₂═C(—H)—C(═O)—O—CH₂—Rf

### CH₂═C(—CH₃)—C(═O)—O—CH₂—Rf

### CH₂═C(—H)—C(═O)—O—(CH₂)₂—Rf

### CH₂═C(—CH₃)—C(═O)—O—(CH₂)₂—Rf

### CH₂═C(—Cl)—C(═O)—O—(CH₂)₂—Rf

### CH₂═C(—F)—C(═O)—O—(CH₂)₂—Rf

### CH₂═C(—Br)—C(═O)—O—(CH₂)₂—Rf

### CH₂═C(—I)—C(═O)—O—(CH₂)₂—Rf

### CH₂═C(—CF₃)—C(═O)—O—(CH₂)₂—Rf

### CH₂═C(—CN)—C(═O)—O—(CH₂)₂—Rf

### CH₂═C(—Rf)—C(═O)—O—(CH₂)₂—Rf

### CH₂═C(—CH₂—C₆H₅)—C(═O)—O—(CH₂)₂—Rf

### CH₂═C(—C₆H₅)—C(═O)—O—(CH₂)₂—Rf

### CH₂═C(—H)—C(═O)—O—(CH₂)₂—N(—CH₃)—SO₂—Rf

### CH₂═C(—F)—C(═O)—O—(CH₂)₂—N(—CH₃)—SO₂—Rf

### CH₂═C(—Cl)—C(═O)—O—(CH₂)₂—N(—CH₃)—SO₂—Rf

### CH₂═C(—CF₃)—C(═O)—O—(CH₂)₂—N(—CH₃)—SO₂—Rf

### CH₂═C(—H)—C(═O)—O—(CH₂)₂—N(—C₂H₅)—SO₂—Rf

### CH₂═C(—F)—C(═O)—O—(CH₂)₂—N(—C₂H₅)—SO₂—Rf

### CH₂═C(—Cl)—C(═O)—O—(CH₂)₂—N(—C₄H₉)—SO₂—Rf

### CH₂═C(—CH₃)—C(═O)—O—CH₂—CH(—OCO—CH₃)—CH₂—Rf

### CH₂═C(—F)—C(═O)—O—CH₂—CH(—OCO—CH₃)—CH₂—Rf

### CH₂═C(—Cl)—C(═O)—O—CH₂—CH(—OCO—CH₃)—CH₂—Rf

### CH₂═C(—H)—C(═O)—O—CH₂—CH(—OH)—CH₂—Rf

### CH₂═C(—F)—C(═O)—O—CH₂—CH(—OH)—CH₂—Rf

### CH₂═C(—Cl)—C(═O)—O—CH₂—CH(—OH)—CH₂—Rf

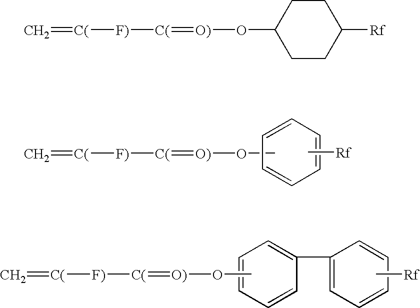

### CH₂═C(—H)—C(═O)—O—(CH₂)₂—S—Rf

### CH₂═C(—H)—C(═O)—O—(CH₂)₂—S—(CH₂)₂—Rf

### CH₂═C(—H)—C(═O)—O—(CH₂)₃—SO₂—Rf

### CH₂═C(—H)—C(═O)—O—(CH₂)₂—SO₂—(CH₂)₂—Rf

### CH₂═C(—H)—C(═O)—NH—(CH₂)₂—Rf

### CH₂═C(—CH₃)—C(═O)—O—(CH₂)₂—S—Rf

### CH₂═C(—CH₃)—C(═O)—O—(CH₂)₂—S—(CH₂)₂—Rf

### CH₂═C(—CH₃)—C(═O)—O—(CH₂)₃—SO₂—Rf

### CH₂═C(—CH₃)—C(═O)—O—(CH₂)₂—SO₂—(CH₂)₂—Rf

### CH₂═C(—CH₃)—C(═O)—NH—(CH₂)₂—Rf

### CH₂═C(—F)—C(═O)—O—(CH₂)₂—S—Rf

### CH₂═C(—F)—C(═O)—O—(CH₂)₂—S—(CH₂)₂—Rf

### CH₂═C(—F)—C(═O)—O—(CH₂)₂—SO₂—Rf

### CH₂═C(—F)—C(═O)—O—(CH₂)₂—SO₂—(CH₂)₂—Rf

### CH₂═C(—F)—C(═O)—NH—(CH₂)₂—Rf

### CH₂═C(—Cl)—C(═O)—O—(CH₂)₂—S—Rf

### CH₂═C(—Cl)—C(═O)—O—(CH₂)₂—S—(CH₂)₂—Rf

### CH₂═C(—Cl)—C(═O)—O—(CH₂)₂—SO₂—Rf

### CH₂═C(—Cl)—C(═O)—O—(CH₂)₂—SO₂—(CH₂)₂—Rf

### CH₂═C(—Cl)—C(═O)—NH—(CH₂)₂—Rf

### CH₂═C(—CF₃)—C(═O)—O—(CH₂)₂—S—Rf

### CH₂═C(—CF₃)—C(═O)—O—(CH₂)₂—S—(CH₂)₂—Rf

### CH₂═C(—CF₃)—C(═O)—O—(CH₂)₂—SO₂—Rf

### CH₂═C(—CF₃)—C(═O)—O—(CH₂)₂—SO₂—(CH₂)₂—Rf

### CH₂═C(—CF₃)—C(═O)—NH—(CH₂)₂—Rf

### CH₂═C(—CF₂H)—C(═O)—O—(CH₂)₂—S—Rf

### CH₂═C(—CF₂H)—C(═O)—O—(CH₂)₂—S—(CH₂)₂—Rf

### CH₂═C(—CF₂H)—C(═O)—O—(CH₂)₂—SO₂—Rf

### CH₂═C(—CF₂H)—C(═O)—O—(CH₂)₂—SO₂—(CH₂)₂—Rf

### CH₂═C(—CF₂H)—C(═O)—NH—(CH₂)₂—Rf

### CH₂═C(—CN)—C(═O)—O—(CH₂)₂—S—Rf

### CH₂═C(—CN)—C(═O)—O—(CH₂)₂—S—(CH₂)₂—Rf

### CH₂═C(—CN)—C(═O)—O—(CH₂)₂—SO₂—Rf

### CH₂═C(—CN)—C(═O)—O—(CH₂)₂—SO₂—(CH₂)₂—Rf

### CH₂═C(—CN)—C(═O)—NH—(CH₂)₂—Rf

### CH₂═C(—CF₂CF₃)—C(═O)—O—(CH₂)₂—S—Rf

### CH₂═C(—CF₂CF₃)—C(═O)—O—(CH₂)₂—S—(CH₂)₂—Rf

### CH₂═C(—CF₂CF₃)—C(═O)—O—(CH₂)₂—SO₂—Rf

### CH₂—C(—CF₂CF₃)—C(═O)—O—(CH₂)₂—SO₂—(CH₂)₂—Rf

### CH₂═C(—CF₂CF₃)—C(═O)—NH—(CH₂)₂—Rf

### CH₂═C(—F)—C(═O)—O—(CH₂)₃—S—Rf

### CH₂═C(—F)—C(═O)—O—(CH₂)₃—S—(CH₂)₂—Rf

### CH₂═C(—F)—O(═O)—O—(CH₂)₃—SO₂—Rf

### CH₂═C(—F)—C(═O)—O—(CH₂)₃—SO₂—(CH₂)₂—Rf

### CH₂═C(—F)—C(═O)—NH—(CH₂)₃—Rf

### CH₂═C(—Cl)—C(═O)—O—(CH₂)₃—S—Rf

### CH₂═C(—Cl)—C(═O)—O—(CH₂)₃—S—(CH₂)₂—Rf

### CH₂═C(—Cl)—C(═O)—O—(CH₂)₃—SO₂—Rf

### CH₂═C(—Cl)—C(═O)—O—(CH₂)₃—SO₂—(CH₂)₂—Rf

### CH₂═C(—CF₃)—C(═O)—O—(CH₂)₃—S—Rf

### CH₂═C(—CF₃)—C(═O)—O—(CH₂)₃—S—(CH₂)₂—Rf

### CH₂═C(—CF₃)—C(═O)—O—(CH₂)₃—SO₂—Rf

### CH₂═C(—CF₃)—C(═O)—O—(CH₂)₃—SO₂—(CH₂)₂—Rf

### CH₂═C(—CF₂H)—C(═O)—O—(CH₂)₃—S—Rf

### CH₂═C(—CF₂H)—C(═O)—O—(CH₂)₃—S—(CH₂)₂—Rf

### CH₂═C(—CF₂H)—C(═O)—O—(CH₂)₃—SO₂—Rf

### CH₂═C(—CF₂H)—C(═O)—O—(CH₂)₃—SO₂—(CH₂)₂—Rf

### CH₂═C(—CN)—C(═O)—O—(CH₂)₃—S—Rf

### CH₂═C(—CN)—C(═O)—O—(CH₂)₃—S—(CH₂)₂—Rf

### CH₂═C(—CN)—C(═O)—O—(CH₂)₃—SO₂—Rf

### CH₂═C(—CN)—C(═O)—O—(CH₂)₃—SO₂—(CH₂)₂—Rf

### CH₂═C(—CF₂CF₃)—C(═O)—O—(CH₂)₃—S—Rf

### CH₂═C(—CF₂CF₃)—C(═O)—O—(CH₂)₃—S—(CH₂)₂—Rf

### CH₂═C(—CF₂CF₃)—C(═O)—O—(CH₂)₃—SO₂—Rf

### CH₂═C(—CF₂CF₃)—C(═O)—O—(CH₂)₃—SO₂—(CH₂)₂—Rf

wherein Rf is a linear or branched fluoroalkyl group or fluoroalkenyl group having 1-21 carbon atoms.

Specific examples of the vinyl ether compound:

### CF₂═C(—F)—O—Rf

### CF₂═C(—F)—O—CH₂—Rf

### CF₂═C(—F)—O—CH₂—CH₂—Rf

### CH₂═C(—H)—O—CH₂—CH₂—Rf

### CF₂═C(—F)—O—CH₂—CH(—OH)—CH₂—Rf

### CH₂═C(—H)—O—CH₂—CH(—OH)—CH₂—Rf

### CH₂═C(—H)—O—(CF₂—CF(—CF₃)—O)₂—Rf

### CH₂═C(—Cl)—O—(CF₂—CF(—CF₃)—O)₂—Rf

wherein Rf is a linear or branched fluoroalkyl group or fluoroalkenyl group having 1-21 carbon atoms.

The fluorine-containing monomer (a) may be a mixture of at least two.

Generally, the monomer (b) having imide group deriving the repeating units (B) is a compound having a carbon-carbon double bond and an imide group (a —CONHCO— linkage). The monomer (b) having imide group may be any of a fluorine-containing monomer or a fluorine-free monomer, but is preferably the fluorine-free monomer.

The monomer (b) having imide group can improve heat resistance of the fluorine-containing polymer. Examples of the monomers (b) include maleimides (total number of the carbon atoms are from 5 to 25) such as maleimide, phenyl maleimide, cyclohexyl maleimide, a linear or branched C₁₋₂₁ alkyl maleimide; imide (meth)acrylate compounds (total carbon number: 5-30, particularly 8-25) [a reaction product among a cyclic acid anhydride (carbon number: 3-15), an amino alcohol (carbon number: 1-15) and (meth)acrylic acid (carbon number: 3)]. The monomer (b) may be a mixture of at least two.

A monomer (c) polymerizable with and other than a monomer (a) and (b) may be used. The monomer (c) may be any of a fluorine-containing monomer and a fluorine-free monomer, but is preferably the fluorine-free monomer. Generally, a monomer (c) is the fluorine-free monomer which does not have the imide group. The monomer (c) derives repeating units (C), can adjust the compatibility between the water- and oil-repellent agent and the thermoplastic resin, and can improve the water- and oil-repellency.

Specific examples of the monomers (c) include ethylene, vinyl acetate, vinyl halides (for example, vinyl chloride), vinylidene halides (for example, vinylidene chloride), acrylonitrile, styrene, polyethylene glycol (meth)acrylate, polypropylene glycol (meth)acrylate, methoxy polyethylene glycol (meth)acrylate, methoxy polypropylene glycol (meth)acrylate, vinyl alkyl ether, isoprene, diacetone acrylamide, (meth)acrylamide, N-methylol acrylamide, hydroxymethyl (meth)acrylate, hydroxyethyl (meth)acrylate, 3-chloro-2-hydroxypropyl (meth)acrylate, N,N-dimethylaminoethyl (meth)acrylate, N,N-diethylaminoethyl (meth)acrylate, butadiene, chloroprene, glycidyl (meth)acrylate, glycerol (meth)acrylate, maleic acid, maleic acid half ester, dibutyl maleate and acetoacetoxyethyl (meth)acrylate, but are not limited to these.

Also, the monomer (c) may be a (meth)acrylate ester containing an alkyl group. The number of carbon atoms of the alkyl group may be from 1 to 30, for example, from 6 to 30, e.g., from 10 to 30, the monomer (c) may be represented by the general formula (2).

### General Formula:

CH₂═CA¹COOA² (2)

wherein A¹ is a hydrogen atom or a methyl group, and A² is a linear or branched alkyl group of CᵣH₂ᵣ₊₁ (r=1-30).

Specific examples of the acrylate include n-butyl (meth)acrylate, 2-ethylhexyl (meth)acrylate, lauryl (meth)acrylate and stearyl (meth)acrylate, but are not limited to these.

The monomer (c) may be a mixture of at least two.

In the fluorine-containing polymer, a weight ratio of the monomer (a) to the monomer (b) is from 10/90 to 95/5, for example, from 20/80 to 90/10, particularly from 30/70 to 80/20. The amount of the monomer (c) may be 0 to 80% by weight, for example, 0.1 to 70% by weight, particularly to 40% by weight, based on the fluorine-containing polymer.

The fluorine-containing polymer can be used as a water- and oil-repellent agent. The water- and oil-repellent agent may consist of only the fluorine-containing polymer, or may contain other ingredients, for example, additives for resin such as an antistatic agent, an ultraviolet rays absorbent agent, an antimicrobial agent, a flame retardant agent, in addition to the fluorine-containing polymer. The amount of other ingredients may be at most 200 parts by weight, for example, 0.01 to 50 parts by weight, particularly 0.1 to 10 parts by weight, based on 1 part by weight of the water- and oil-repellent agent.

The fluorine-containing polymer of the present invention may be any of a random copolymer, a block copolymer and a graft copolymer. A polymerization method of preparing the fluorine-containing polymer is any of a bulk polymerization, a solution polymerization, a suspension polymerization, and an emulsion polymerization. A photopolymerization, a radiation polymerization and the like may be also used. A polymerization initiator may be a conventionally used initiator such as an organic azo compound, peroxide and persulfate. A chain transfer agent may be a conventionally used mercapto compound (for example, 2-mercaptoethanol and methyl thioglycolate); and an alpha-methyl styrene dimer:

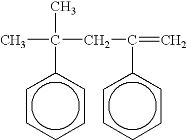

which was adopted in the JP-A-10-168324 proposed by the present inventors. A polymerization medium may be a known organic solvent such as acetone, isopropyl alcohol and ethyl acetate; and water for the emulsion polymerization. A surfactant may be any of cationic, nonionic, anionic and amphoteric surfactants.

After the polymerization, materials except the fluorine-containing polymer, such as the surfactant, the organic solvent and water are removed by a conventionally known method such as the method that the polymer is refined in a large quantity of poor solvents (for example, methanol) and dried under reduced pressure, so that the fluorine-containing polymer is obtained.

The weight-average molecular weight of the fluorine-containing polymer may be, for example, from 1,000 to 200,000, particularly from 2,000 to 100,000, especially from 3,000 to 50,000. The average molecular weight is measured by a gel permeation chromatography in terms of polystyrene.

Examples of the thermoplastic resin having the addition of the fluorine-containing resin include a polyolefin resin (for example, polyethylene, polypropylene, a copolymer of ethylene and propylene, a copolymer of ethylene or propylene and C₄-C₂₀ alpha-olefin, a terpolymer of ethylene, propylene and C₄-C₂₀ alpha-olefin, a copolymer of ethylene and vinyl acetate, a copolymer of propylene and vinyl acetate, a copolymer of styrene and alpha-olefin, polybutylene and polyisobutylene), a polyamide resin (for example, nylon 6, nylon 12, nylon 66, aromatic nylon), a polyester resin (for example, polyethylene terephthalate and polybutylene terephthalate), a polyether resin, a polyetherester resin, a polyacrylate resin an ethylenealkyl acrylate resin a polydiene resin (for example, a polybutadiene and a copolymer of isobutylene and isoprene), a polyurethane resin, a polyetheretherketone resin, a polyetherimide resin, a polyethersulfone resin, polyphenylene sulfide resin, and a polycarbonate resin. The thermoplastic resin may be a mixture of at least two.

The thermoplastic resin may contain additives (that is, auxiliaries), for example, a dye, a pigment, an antistatic agent, an antioxidant, a photo-stabilizers, a UV-absorber, a neutralizer, a nucleating agent, an epoxy-stabilizer, a sliding agent, a fungus preventing agent, a flame retardant, and a plasticizer, depending on the necessity.

The thermoplastic resin composition of the present invention can be prepared by kneading (for example, melt-kneading) 90 to 99.9% by weight, for example, 95 to 99.5% by weight of the thermoplastic resin with 0.1 to 10% by weight, 0.5 to 5% by weight of the water- and oil-repellent agent (in particular, the fluorine-containing polymer alone). Generally, the thermoplastic resin and the fluorine-containing polymer are compatibilized in a melting state. The kneading can be conducted by conventional procedures, for example, a single screw extruder, a twin screw extruder and a roll. Thus obtained resin composition can be molded by conventional procedures such as an extrusion molding process, an injection molding process, a compression molding process and a film formation by press. The resin composition may be molded into various molded articles such as a fiber, a film and a tube. The obtained molded article may be heat-treated in an oven, a drying oven and the like, after the molding. The fiber may have a diameter of 0.2 to 2000 micrometers, for example, 0.5 to 50 micrometers, and a length of 0.2 mm to 200 mm, for example, 2 to 30 mm. The thus obtained molded article can be used for the products such as household articles (for example, washbowl), stationery (for example, ink bottle), an interior decoration material, a sanitary article and a medical article.

The thermoplastic resin composition of the present invention may be made in the form of a non-woven fabric. The non-woven fabric can be obtained by a carding method, an air laid method, a paper manufacturing method, or a melt blown method or a spun bond method wherein the non-woven fabric is directly obtained from the melt extrusion. The basis weight of the non-woven fabric is not particularly limited, but may be from 0.1 to 1000 g/m². The basis weight of the non-woven fabric is, for example, from 5 to 60 g/m² for a surface material of a liquid-absorbing article and the like; from 10 to 500 g/m² for an absorbing article, a wiper and the like; from 8 to 1000 g/m² for a filter, according to uses of the non-woven fabric.

Hereinafter, the present invention will be illustrated in detail by the following Examples, which do not limit the present invention.

Hereinafter, % and part are % by weight and part by weight, unless specified.

### Preparative Example 1

CF₃CF₂(CF₂CF₂)ₙCH₂CH₂COOCH═CH₂ (mixture of the compounds wherein n is 3, 4 and 5, in which an average of n is 3.1) (2.0 g), N-phenyl maleimide (3.0 g), ethyl acetate (20.0 g) were charged into a 100 cc four-necked flask equipped with a thermometer, a stirrer, a nitrogen-introducing tube and a condenser and the atmosphere in the flask was replaced with nitrogen for about 30 minutes, and the content of the flask was heated to 75° C. Alpha-methyl styrene dimer (0.1 g) and t-butyl peroxypivalate (0.1 g) were added and the polymerization reaction was conducted under nitrogen atmosphere at 75° C. for 8 hours. The conversion of the monomer by the gas chromatography was 95%. The content was refined in a large quantity of methanol afterwards, the content was dried under reduced pressure to give a fluorine-containing polymer. The composition of the polymer was almost the same as the composition of the charged monomer.

As to the heat resistance of the resultant fluorine-containing polymer, by using TG/DTA 6200 manufactured by SII Nanotechnology Inc., a weight loss of the fluorine-containing polymer was measured under the application of heating condition at a rate of 10° C./min from 20° C. under nitrogen (200 ml/min.) atmosphere. Table 1 shows a composition for polymerization, and a temperature at which the weight loss degree of 1% by weight as the heat resistance of the fluorine-containing polymer is observed for the fluorine-containing polymer.

### Preparative Example 2

A fluorine-containing polymer is prepared in the same procedure as in Preparative Example 1 except that CF₃CF₂(CF₂CF₂)ₙCH₂CH₂COOCH═CH₂ (a mixture of compounds wherein n is 3, 4 and 5, in which an average of n is 3.1) was changed to CF₃(CF₂)₃CH₂CH₂OCOCH═CH₂. In the same manner, the degree of weight loss was measured. Table 1 shows a composition for polymerization, and a temperature at which the weight loss degree of 1% by weight as the heat resistance of the fluorine-containing polymer is observed for the fluorine-containing polymer.

### Preparative Example 3

A fluorine-containing polymer is prepared in the same procedure as in Preparative Example 1 except that N-phenyl maleimide was changed to stearyl methacrylate. In the same manner, the degree of weight loss was measured. Table 1 shows a composition for polymerization, and a temperature at which the weight loss degree of 1% by weight as the heat resistance of the fluorine-containing polymer is observed for the fluorine-containing polymer.

### Preparative Example 4

A fluorine-containing polymer is prepared in the same procedure as in Preparative Example 2 except that N-phenyl maleimide was changed to stearyl methacrylate. In the same manner, the degree of weight loss was measured. Table 1 shows a composition for polymerization, and a temperature at which the weight loss degree of 1% by weight as the heat resistance of the fluorine-containing polymer is observed for the fluorine-containing polymer.

TABLE 1
Polymerization composition and heat resistance of fluorine-containing polymer

| | Prep. | Prep. | Prep. | Prep. |
|---|---|---|---|---|
| | Example | Example | Example | Example |
| | 1 | 2 | 3 | 4 |
| CF₃CF₂(CF₂CF₂)ₙCH₂CH₂COOCH═CH₂ | 40% | — | 40% | — |
| n = 3, 4, 5 | | | | |
| CF₃(CF₂)₃CH₂CH₂OCOCH═CH₂ | — | 40% | — | 40% |
| N-phenyl maleimide | 60% | 60% | — | — |
| Stearyl methacrylate | — | — | 60% | 60% |
| Heat-resistant | 320° C. | 325° C. | 218° C. | 234° C. |
| (Temperature at which the | | | | |
| weight loss degree of 1% by | | | | |
| weight is observed for the | | | | |
| fluorine-containing polymer) | | | | |

From the results of Table 1, it is understood that the fluorine-containing polymer containing N-phenyl maleimide has the improved heat resistance in comparison with the fluorine-containing polymer free from N-phenyl maleimide.

### Example 1

NOVATEC PP MG03B (isotactic polypropylene (PP) available from Japan Polypropylene Corporation) (89 parts by weight), TAFTHREN T-3512 (manufactured by Sumitomo Chemical Co., Ltd.) (amorphous polypropylene (PP)) (10 parts by weight) and the fluorine-containing polymer prepared in Preparative Example 1 (1 part by weight) were melt-kneaded at 180° C. by a twin-screw extruder, and then the mixture was molded by heat press to give a film.

The contact angle of a mixture liquid of IPA/water (70/30 (volume ratio)) and the contact angle of n-hexadecane were measured in order to evaluate the alcohol-repellency (water-repellency) and oil-repellency of this film. The contact angle was measured in an automatic contact angle meter by dripping one drop of liquid (2 μL) from a microsyringe on a film positioned horizontally. Performance evaluation results are shown in table 2.

### Example 2

A film was prepared and the evaluation was conducted in the same manner as in Example 1, except that the fluorine-containing polymer of Preparative Example 1 was changed to the fluorine-containing polymer of Preparative Example 2. Performance evaluation results are shown in Table 2.

### Comparative Example 1

A film was prepared and the evaluation was conducted in the same manner as in Example 1, except that the fluorine-containing polymer of Preparative Example 1 was changed to the fluorine-containing polymer of Preparative Example 3. Performance evaluation results are shown in Table 2.

### Comparative Example 2

A film was prepared and the evaluation was conducted in the same manner as in Example 1, except that the fluorine-containing polymer of Preparative Example 1 was changed to the fluorine-containing polymer of Preparative Example 4. Performance evaluation results are shown in Table 2.

### Example 3

REONA 1402S (nylon-66 manufactured by Asahi Chemical Industry Co., Ltd.) (99 parts by weight) and the fluorine-containing polymer of Preparative Example 1 (1 part by weight) were melt-kneaded at 280° C. in a twin-screw extruder, and then the mixture was molded by heat press to give a film.

The contact angle of a mixture liquid of IPA/water (70/30 (volume ratio)) and the contact angle of n-hexadecane were measured in order to evaluate the alcohol-repellency (water-repellency) and oil-repellency of this film. Performance evaluation results are shown in Table 3.

### Example 4

A film was prepared and the evaluation was conducted in the same manner as in Example 3, except that the fluorine-containing polymer of Preparative Example 1 was changed to the fluorine-containing polymer of Preparative Example 2. Performance evaluation results are shown in Table 3.

### Comparative Example 3

A film was prepared and the evaluation was conducted in the same manner as in Example 3, except that the fluorine-containing polymer of Preparative Example 1 was changed to the fluorine-containing polymer of Preparative Example 3. Performance evaluation results are shown in Table 3.

### Comparative Example 4

A film was prepared and the evaluation was conducted in the same manner as in Example 3, except that the fluorine-containing polymer of Preparative Example 1 was changed to the fluorine-containing polymer of Preparative Example 4. Performance evaluation results are shown in Table 3.

### Example 5

KURAPET KS710B (polyethylene terephthalate (PET) manufactured by Kuraray Co., Ltd.) (99 parts by weight) and the fluorine-containing polymer of Preparative Example 1 (1 part by weight) were melt-kneaded at 280° C. in a twin-screw extruder, and then the mixture was molded by heat press to give a film.

The contact angle of a mixture liquid of IPA/water (70/30 (volume ratio)) and the contact angle of n-hexadecane were measured in order to evaluate the alcohol-repellency (water-repellency) and oil-repellency of this film. Performance evaluation results are shown in Table 4.

### Example 6

A film was prepared and the evaluation was conducted in the same manner as in Example 5, except that the fluorine-containing polymer of Preparative Example 1 was changed to the fluorine-containing polymer of Preparative Example 2. Performance evaluation results are shown in Table 4.

### Comparative Example 5

A film was prepared and the evaluation was conducted in the same manner as in Example 5, except that the fluorine-containing polymer of Preparative Example 1 was changed to the fluorine-containing polymer of Preparative Example 3. Performance evaluation results are shown in Table 4.

### Comparative Example 6

A film was prepared and the evaluation was conducted in the same manner as in Example 5, except that the fluorine-containing polymer of Preparative Example 1 was changed to the fluorine-containing polymer of Preparative Example 4. Performance evaluation results are shown in Table 4.

### Reference Comparative Example 1

NOVATEC PP MG03B (isotactic polypropylene (PP) available from Japan Polypropylene Corporation) (90 parts by weight) and TAFTHREN T-3512 (manufactured by Sumitomo Chemical Co., Ltd.) (amorphous polypropylene (PP)) (10 parts by weight) were melt-kneaded at 180° C. by a twin-screw extruder, and then the mixture was molded by heat press to give a film.

The contact angle of a mixture liquid of IPA/water (70/30 (volume ratio)) and the contact angle of n-hexadecane were measured in order to evaluate the alcohol-repellency (water-repellency) and oil-repellency of this film. Performance evaluation results are shown in Table 2.

### Reference Comparative Example 2

REONA 1402S (nylon-66 manufactured by Asahi Chemical Industry Co., Ltd.) (100 parts by weight) was melt-kneaded at 280° C. in a twin-screw extruder, and then the mixture was molded by heat press to give a film.

The contact angle of a mixture liquid of IPA/water (70/30 (volume ratio)) and the contact angle of n-hexadecane were measured in order to evaluate the alcohol-repellency (water-repellency) and oil-repellency of this film. Performance evaluation results are shown in Table 3.

### Reference Comparative Example 3

KURAPET KS710B (poly ethylene terephthalate (PET) manufactured by Kuraray Co., Ltd.) (100 parts by weight) was melt-kneaded at 280° C. in a twin-screw extruder, and then the mixture was molded by heat press to give a film.

The contact angle of a mixture liquid of IPA/water (70/30 (volume ratio)) and the contact angle of n-hexadecane were measured in order to evaluate the alcohol-repellency (water-repellency) and oil-repellency of this film. Performance evaluation results are shown in Table 4.

TABLE 2
Performance evaluation results for PP/amorphous PP
resin

| | | | | | | Ref. |
|---|---|---|---|---|---|---|
| | | | | Com. | Com. | Com. |
| | | Ex. 1 | Ex. 2 | Ex. 1 | Ex. 2 | Ex. 1 |
| PP | | 89% | 89% | 89% | 89% | 90% |
| Amorphous PP | | 10% | 10% | 10% | 10% | 10% |
| Fluorine-containing | | 1% | 1% | 1% | 1% | — |
| polymer | | (Prep. | (Prep. | (Prep. | (Prep. | |
| | | Ex. 1) | Ex. 2) | Ex. 3) | Ex. 4) | |
| Contact | IPA/water | 45 | 40 | 45 | 40 | 30 |
| angle | n-Hexa- | 29 | 28 | 17 | 15 | 10 |
| (°) | decane | | | | | |

PP: Polypropylene

TABLE 3
Performance evaluation results for nylon-66 resin

| | | | | | | Ref. |
|---|---|---|---|---|---|---|
| | | | | Com. | Com. | Com. |
| | | Ex. 3 | Ex. 4 | Ex. 3 | Ex. 4 | Ex. 2 |
| Nylon-66 | | 99% | 99% | 99% | 99% | 100% |
| Fluorine-containing | | 1% | 1% | 1% | 1% | — |
| polymer | | (Prep. | (Prep. | (Prep. | (Prep. | |
| | | Ex. 1) | Ex. 2) | Ex. 3) | Ex. 4) | |
| Contact | IPA/water | 44 | 40 | 30 | 31 | 28 |
| angle | n-Hexa- | 28 | 28 | 12 | 12 | 10 |
| (°) | decane | | | | | |

TABLE 4
Performance evaluation results for polyethylene
terephthalate resin

| | | | | | | Ref. |
|---|---|---|---|---|---|---|
| | | | | Com. | Com. | Com. |
| | | Ex. 5 | Ex. 6 | Ex. 5 | Ex. 6 | Ex. 3 |
| PET | | 99% | 99% | 99% | 99% | 100% |
| Fluorine-containing | | 1% | 1% | 1% | 1% | — |
| polymer | | (Prep. | (Prep. | (Prep. | (Prep. | |
| | | Ex. 1) | Ex. 2) | Ex. 3) | Ex. 4) | |
| Contact | IPA/water | 43 | 40 | 29 | 29 | 28 |
| angle | n-Hexa- | 28 | 29 | 12 | 11 | 11 |
| (°) | decane | | | | | |

From the results of Tables 2, 3 and 4, it is understood that the fluorine-containing polymer containing N-phenyl maleimide has the more excellent water- and oil-repellency for a wide range of resin application in comparison with the fluorine-containing polymer free from N-phenyl maleimide.

1. A fluorine-containing polymer comprising:
(A) repeating units derived from a fluorine-containing monomer having a fluoroalkyl group or fluoroalkenyl group, and
(B) repeating units derived from a monomer having an imide group,
wherein a weight ratio of the repeating units (A) to the repeating units (B) is from 10/90 to 95/5.

2. The fluorine-containing polymer according to claim 1,
wherein the fluorine-containing monomer is represented by the general formula (1):
C(-A)(-D)=C(—X)—Y-[Q-Z-]ₚ-T-Rf (1)
wherein
A, D and X each is a hydrogen atom, a methyl group, a linear or branched alkyl group having 2 to 20 carbon atoms, a fluorine atom, a chlorine atom, a bromine atom, an iodine atom, a CFL¹L² group (wherein L¹ and L² is a hydrogen atom, a fluorine atom or a chlorine atom), a cyano group, a linear or branched fluoroalkyl group having 1 to 20 carbon atoms, a substituted or unsubstituted benzyl group, or a substituted or unsubstituted phenyl group;
Y is —C(═O)—O—, —C(═O)—NH—, —O— or —O—(CF₂CF(—CF₃)O—)_{g}— in which g is 1 to 21;
Q is —(CH₂)ₙ— or —(CH₂)ₙ—N(-Q¹)- in which n is 1 to 10, Q¹ is a hydrogen atom or C_{q}H_{2q+1} wherein q is 1 to 30;
Z is —S—, —SO—, —SO₂— or —C(—Z¹)(—Z²)— in which Z¹ and Z² each is a hydrogen atom, —OH or —OCO—C_{w}H_{2w+1} wherein w is 1 to 30;
T is a direct bond, an aliphatic group having 1 to 10 carbon atoms, or an aromatic or cycloaliphatic group having 6 to 20 carbon atoms;
Rf is a linear or branched fluoroalkyl group or fluoroalkenyl group having 1 to 21 carbon atoms; and
p is 0 or 1.

3. The fluorine-containing polymer according to claim 1, wherein the monomer having the imide group is a compound having a carbon-carbon double bond and an imide group.

4. The fluorine-containing polymer according to claim 1, wherein the monomer having the imide group is at least one compound selected from the group consisting of maleimide, phenyl maleimide, cyclohexyl maleimide, and a linear or branched N-alkyl maleimide having 1 to 21 carbon atoms.

5. The fluorine-containing polymer according to claim 1, which further contains (C) repeating units derived from a monomer polymerizable with and other than the fluorine-containing monomer and the imide group-containing monomer, in the amount of 0.01 to 70% by weight based on the polymer.

6. A water- and oil-repellent agent comprising the fluorine-containing polymer according to claim 1.

7. The thermoplastic resin composition which comprises 90 to 99.9% by weight of a thermoplastic resin and 0.1 to 10% by weight of the water- and oil-repellent agent according to claim 6.

8. A molded article shaped from the thermoplastic resin composition according to claim 7 is molded.

9. The molding article according to claim 8, which is used as a household article, stationery, a building material, an interior decoration material, a sanitary article or a medical article.

10. A nonwoven fabric formed from fibers comprising the thermoplastic resin composition according to claim 7.
